(19) United States
(12) Patent Application Publication
(10) Pub. No.: US 2012/0054619 A1
(43) Pub. Date: Mar. 1, 2012

(54) LOCALIZED MEDIA CONTENT EDITING

(75) Inventors: Elaine M. Spooner, Winnetka, CA (US); John D. Koscheka, Los Angeles, CA (US); Michael S. Bessolo, Glendale, CA (US); J. Craig D. Russell, Playa Vista, CA (US); Greg McCarthy, Santa Monica, CA (US); Venkata Nagaraju Mantena, Irvine, CA (US); Ramesh Gurram, Irvine, CA (US); Marwan Ammar, Los Angeles, CA (US)

(73) Assignee: FOX ENTERTAINMENT GROUP, INC., Los Angeles, CA (US)

(21) Appl. No.: 13/222,682

(22) Filed: Aug. 31, 2011

Related U.S. Application Data
(60) Provisional application No. 61/378,787, filed on Aug. 31, 2010.

(51) Int. Cl. G06F 3/01

(52) U.S. Cl. 715/723

(57) ABSTRACT

A method, system, apparatus, article of manufacture, and a computer readable storage medium provide the ability to edit media content in a computer system. A server computer provides access to a repository of media content via a website accessible on the Internet worldwide client computers. The website is configured to provide preview screening access to licensed media content to authorized client users. The licensed media content includes titles of audio-visual media content. In addition, the website is configured to enable editing of the licensed media content using the preview screening.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Provisional Patent Application Ser. No. 61/378,787 filed on Aug. 31, 2010, entitled “LOCALIZED MEDIA CONTENT EDITING”, by ELAINE M. SPOONER, JOHN D. KOSCHEKA, MICHAEL S. BESSOLO, J. CRAIG D. RUSSELL, GREG MCCARTHY, VENKATA NAGARAJU MANTENA, RAMESH GURRAM, and MARWAN AMMAR, Attorney Docket No. 241.15-US-P1.

This application is related to the following co-pending and commonly-assigned patent application(s), which applications are incorporated by reference herein:

U.S. patent application Ser. No. 13/090,993, entitled “DIGITAL DELIVERY SYSTEM AND USER INTERFACE FOR ENABLING THE DIGITAL DELIVERY OF MEDIA CONTENT”, by ELAINE M. SPOONER, JOHN D. KOSCHEKA, MICHAEL S. BESSOLO, MARK L. SIMPSON, JEAN L. YUAN, J. CRAIG D. RUSSELL, CHRISTOPHER M. BETTES, GREG MCCARTHY, SRINIVAS KUNDULA, and VENKATA NAGARAJU MANTENA, Attorney Docket No. 241.12-US-U1, filed on Apr. 20, 2010, which application claims priority to U.S. Provisional Patent Application Ser. No. 61/326,538, entitled “DIGITAL DELIVERY SYSTEM AND USER INTERFACE FOR ENABLING THE DIGITAL DELIVERY OF MEDIA CONTENT”, by ELAINE M. SPOONER, JOHN D. KOSCHEKA, MICHAEL S. BESSOLO, MARK L. SIMPSON, JEAN L. YUAN, J. CRAIG D. RUSSELL, CHRISTOPHER M. BETTES, GREG MCCARTHY, SRINIVAS KUNDULA, and VENKATA NAGARAJU MANTENA, Attorney Docket No. 241.12-US-P1, filed on Apr. 21, 2010;

U.S. patent application Ser. No. 13/090,997, entitled “CUSTOMIZED BILLBOARD WEBSITE ADVERTISEMENTS”, by ELAINE M. SPOONER, JOHN D. KOSCHEKA, MICHAEL S. BESSOLO, MARK L. SIMPSON, JEAN L. YUAN, J. CRAIG D. RUSSELL, CHRISTOPHER M. BETTES, and GREG MCCARTHY, Attorney Docket No. 241.13-US-U1, filed on Apr. 20, 2010, which application claims priority to U.S. Provisional Patent Application Ser. No. 61/326,544, entitled “CUSTOMIZED BILLBOARD WEBSITE ADVERTISEMENTS”, by ELAINE M. SPOONER, JOHN D. KOSCHEKA, MICHAEL S. BESSOLO, MARK L. SIMPSON, JEAN L. YUAN, J. CRAIG D. RUSSELL, CHRISTOPHER M. BETTES, and GREG MCCARTHY, Attorney Docket No. 241.13-US-P1, filed on Apr. 21, 2010;

U.S. patent application Ser. No. 13/091,005, entitled “MEDIA ASSET/CONTENT SECURITY CONTROL AND MANAGEMENT SYSTEM”, by ELAINE M. SPOONER, JOHN D. KOSCHEKA, MICHAEL S. BESSOLO, MARK L. SIMPSON, JEAN L. YUAN, J. CRAIG D. RUSSELL, CHRISTOPHER M. BETTES, GREG MCCARTHY, SRINIVAS KUNDULA, and VENKATA NAGARAJU MANTENA, Attorney Docket No. 241.14-US-U1, filed on Apr. 20, 2010, which application claims priority to U.S. Provisional Patent Application Ser. No. 61/326,549, entitled “MEDIA ASSET/CONTENT SECURITY CONTROL AND MANAGEMENT SYSTEM”, by ELAINE M. SPOONER, JOHN D. KOSCHEKA, MICHAEL S. BESSOLO, MARK L. SIMPSON, JEAN L. YUAN, J. CRAIG D. RUSSELL, CHRISTOPHER M. BETTES, GREG MCCARTHY, SRINIVAS KUNDULA, and VENKATA NAGARAJU MANTENA, Attorney Docket No. 241.14-US-P1, filed on Apr. 21, 2010; and

U.S. patent application Ser. No. 12/947,642, entitled “NON-DESTRUCTIVE FILE BASED MASTERING FOR MULTIPLE LANGUAGES AND VERSIONS”, by ARJUN RAMAMURTHY and GEOFFREY A. BLODER, Attorney Docket No. 241.7-US-U1, filed on Nov. 16, 2010, which application claims priority to U.S. Provisional Patent Application Ser. No. 61/261,653, entitled “NON-DESTRUCTIVE FILE BASED MASTERING FOR MULTIPLE LANGUAGES AND VERSIONS”, by ARJUN RAMAMURTHY and GEOFFREY A. BLODER, Attorney Docket No. 241.7-US-P1, filed on Nov. 16, 2009.

### BACKGROUND OF THE INVENTION

1. Field of the Invention

The present invention relates generally to the editing of media content, and in particular, to a method, apparatus, system, article of manufacture, and user interface that provides a language localization portal used to input local language information including subtitles and censorship edits that are used to create an edited version of media content and further enables digital versioning across workflows.

2. Description of the Related Art

Media content is often created in a particular language (e.g., English, German, French, etc.). However, when distributing such content internationally, such content needs to be translated into a different language. More particularly, media content often contains text in a particular language that needs to be translated. Different types of text that may be utilized in media content include localized subtitles, texted shots, and forced subtitles. Dubbers are editors that review the media content, identify portions of the content containing the relevant text (referred to as mark-up information) and specify the new replacement text to be used.

The replacement text and mark-up information are provided to an editor who performs the actual edits (e.g., using a non-linear video editing system) and creates the localized version of the media content. Such edits are often performed on expensive computationally expensive computers. In other words, the dubbers provide the replacement text (in the different language) and information regarding what text in a media clip should be replaced while editors perform the actual edits to create the localized media content. However, in the prior art, the localized editing may be performed in the local geographic area and never provided back to the media content owner. Further, to permit such editing, the media content owner may have to deliver significant portions of media content in high-definition (or high quality) to the recipient where the edits are performed. Such delivery may consume significant bandwidth and may have security vulnerabilities for the highly valuable media content.

In addition to the limitations described above, prior art systems fail to provide an automated, integrated, end-to-end file-based delivery workflow that includes such editing capabilities. Although prior art systems may deliver product digitally to customers, the processes addressed by such a digital delivery system are manual and exist entirely outside of the media content owner's system workflows (i.e., they are not an integrated part of the delivery system). Accordingly, media content owners are prevented from creating an automated, integrated delivery solution.

For example, when localizing content, third-parties involved in the localization process, (i.e., dubbing or subtitling content), use their own systems to create text-based video inserts. Because these systems are not integrated with a media content owner's (e.g., FOX™) delivery portal, localized content is supplied back to the media content owner via physical media. The physical media is eventually integrated with other media and encoded to create a final, localized version of a program. The extra steps involved to ship, assemble and encode content causes time delays with supplying content back to end-users.

Accordingly, it is desirable to provide online tools that address these formerly distinct processes, thereby eliminating manual, distinct processes and establishing a workflow that integrates directly with a media content owner's overall digital supply chain. In other words, it is desirable to provide an efficient and easy-to-use mechanism to not only perform the preliminary editing (i.e., dubbing) but also to deliver the localized media content product via a single integrated secure system. Such problems may be better understood with an explanation of prior art media content and the editing/delivery process.

Many types and pieces of information or media content may be utilized as part of the broadcast, advertisement, and sale of such content. Content from various studios (e.g., FOX™) may include:
Over 2,500 Feature Films; over 14,000 Television Series, Seasons and Episodes; and over 1,000 Specials, Movies of the Week and MiniSeries;
Over 100,000 images: Production Stills, Logos, Artwork, Gallery and Episodic Photos;
Over 12,000 Scripts and over 10,000 Music Cue Sheets;
Over 7,300 trailers and other promotional videos;
Over 2,500 episodes for screening;
Over 9,300 broadcast quality files, representing over 700 episodes; and
Over 1,000 broadcast quality promotional videos (Television spots, etc.).

Such media content (that includes both audio and video), that was originally created domestically, is often delivered to international broadcasters in the local language, with local language subtitles and captions. Further, it may be desirable for the recipients/broadcasters of such media content to “localize” the content (e.g., inserting local title information, subtitles, censorship edits, etc.) or to customize/create customized promotional materials based on media content (e.g., reformatting such content based on local broadcast standards, creating commercials targeting recipients/viewers in their local jurisdiction, etc.). Prior art methodologies fail to provide an efficient and easy mechanism for both delivering the media content and enabling the editing of such content (referred to as localization).

Today's physical media-based distribution model is inefficient and subject to challenges including import-export delays, courier, flight or customs problems. In addition, the reliance on fuel-based logistics during product shipping is counter to television distribution and its licensees' carbon neutral operational goals. Finally, physical media-based distribution is expensive with dependencies on manufacturing, shipping and physical media management.

Prior art techniques used to fulfill its customer's requests for advertising and publicity materials required the physical distribution of such materials on physical paper—e.g., slides and transparencies, ad-slicks (camera-ready advertisements of varying sizes that are used in print media such as newspapers and magazines), scripts and music cue sheets. Slides would be duplicated at a photo lab and scripts would be photocopied. The materials would then be boxed up and shipped out to customers such as international broadcasters. These boxes would often get held up at customs, or the materials would be misplaced by the customer—adding to the expense of both time and money.

To overcome some of the prior art problems, digital processes have been reshaping all aspects of the broadcast television industry. Product is now regularly digitally recorded, edited and distributed to audiences via server-based play out. This evolution may naturally extend to the content supply chain and distributor relationships whereby physical media and shipping will soon become obsolete means for content delivery. In this regard, websites have been developed where customers were able to download advertising and publicity materials needed whenever (and as often) as necessary. Instead of slides, customers downloaded JPGs; instead of paper scripts, downloadable PDFs were available. Written information like synopses, cast and crew biographies, awards, and press quotes were also available on such web sites (e.g., the FOXFAST™ website/product delivery mechanism).

Security mechanisms may also exist on such prior art web sites. Such security mechanisms included password-protection that was tied into a studio's television distribution sales system so customers were only given access to materials for the television series and films that the customer currently licensed from the particular studio. However, such a limited system would not allow the customer to view all of the assets available for the customer to license. In this regard, a television distribution sales group is continuously selling titles from a studio's entire catalog, and since customers can only see titles they already licensed in prior art websites, the need for an overall comprehensive catalog site was desirable.

To overcome such problems, a non-password protected catalog website was developed in the prior art to showcase all titles (e.g., features, television series, specials, movies of the week, mini series, etc.) available from a particular entity. Such a prior art website provided the ability to search assets using a variety of criteria including actor, award, box office, genre, and synopsis key words (e.g. all titles about “baseball”).

In addition to the above websites, a further password-protected website was developed in the prior art to allow customers to screen television shows and movies without waiting for a digital video disc (DVD) (and saving the costs of burning and shipping such discs as well). Such screening was viewed as a desirable pre-sales tool. Digital rights management (DRM) was used in such prior art websites to protect the content from unauthorized viewing and piracy.

However, for a media content owner to efficiently and easily deliver pre-sales and sold content to a customer while allowing a customer to easily and efficiently browse all content and receive such content was not provided by the above prior art systems. Instead, customers were forced to utilize multiple websites for different purposes and media content owners did not have the flexibility to easily manage, sample, and deliver such content to both prospective and actual customers. In addition, prior art systems failed to provide the ability to digitally deliver broadcast quality digital files. Instead the prior art required the duplication of a tape and the shipping of the tape overseas.

Thus, the prior art had many problems and deficiencies including:
massive distribution costs to create and ship tapes;
recurring and substantial sunk costs caused by the cost to manage physical media;
product that can leak to the internet prior to a local market telecast;
content leaks that can impact the perceived value of a product;
accelerated demand to ship, schedule, and broadcast programs internationally on the heels of U.S. broadcasts; and
greater attention to physically manage higher content volumes against increasingly intense deadlines based on the accelerated demand to air products.

In addition to the above, one may note that to utilize content created domestically in the United States (or in English), international clients (or content owner affiliates or designated post facilities), often manually edit the domestic audio and video based on the foreign territory's local criteria to create their own localized version. Further, some domestic markets may desire to create their own customized or localized version of the media content. Thus, localized versions have been edited for content—commercial breaks, black frames, etc. may be pulled or reformatted, texted shots (such as overlays) may be translated and recreated, and localized credits (e.g., end credits) may be created. For example, all commercials may be removed for an Italian version of a television program and played sequentially upon the conclusion of the program. Alternatively, local commercials may be inserted into a domestic localized version.

Accordingly, the localized version of content includes audio and video that have been edited together. Further yet, the localized content that has been created is specific to a particular broadcast standard. For example, an Italian master may be created in standard definition PAL 4×3 aspect ratio, as that is the prevalent broadcast standard. However, it may be desirable to also create an Italian based NTSC16×9 version or a version in a different format for broadcast.

To create such localized content, prior art systems require the users to manually/individually edit/customize the media content. As part of the editing process, non-linear video editing has developed where any frame in a digital video clip can be accessed at any time (versus that of manual cutting and splicing of physical tapes/negatives containing the recorded media). Nonetheless, due to the fidelity of the original media content, sophisticated and expensive editing equipment is required. Accordingly, non-linear video editing systems have been developed where editors work on lower fidelity copies of the media content on equipment with (usually) lower processing capabilities and cost. Edit decisions made by the editors are recorded in an edit decision list (EDL) which can then be used on the high fidelity systems to perform the actual edits. An EDL complies with a particular format that can be used by multiple different editing systems. Accordingly, prior art systems still require significant experience to operate the editing applications (on both the high and low fidelity systems). Such an editing process is both time and computationally expensive.

As part of the localized editing process, certain text based content may be created that is localized. As described above, the different types of text that may be utilized in media content include localized subtitles, texted shots, and forced subtitles.

Localized subtitles are standard titles displaying the translation (audio or otherwise) of a dialog or other content displayed on a screen. For example, an English language film may be translated into German and the German subtitles are displayed somewhere on the screen. Alternatively, in an English language film, a scene may occur in Germany with German being spoken in which case English subtitles may be shown somewhere on the screen.

A texted shot may include information displayed about a particular scene such as a time of day (e.g., Jan. 5, 2010-5:00 PM), location (e.g., Warehouse on Fifth Street, New York), etc.

Forced subtitles are text within a scene that is relevant to the particular scene. For example, a highway/freeway sign, magazine name, etc. may be in a particular language and the forced subtitle is displayed somewhere on the screen translating such text.

Prior art techniques fail to provide the ability to specify the ability to easily and efficiently collect and submit localized subtitles, texted shots, and forced subtitles in a secure manner

### SUMMARY OF THE INVENTION

One or more embodiments of the invention provide an online digital delivery system using a singular comprehensive easy-to-use website that provides the capability to perform editing and create customized localized content in an efficient manner. In other words, embodiments enable the use of an online tool that provides authorized users the ability to access self-service functions to edit video, pull video clips or still images, annotate works-in-progress for review, transcribe and translate documents, and create localized language text in a secure environment to create customized broadcast video versions for specific use. By maintaining editing and localization technology within the online environment, embodiments provide a digital end-to-end workflow that ensures all parts of the versioning process remain within a digital environment.

Embodiments of the invention may also include the ability to edit content directly on an integrated website, a shopping cart-like queue for managing assets to be edited, broadcast files and still image captures delivered based on proxy video edits and customization, and internal work-in-progress review and annotation capabilities. Potential users of embodiments of the invention include language dubbing and subtitling vendors, censorship editors, production users, users requiring promotional video clips or still images from broadcast quality video, and website users that are granted access to features such as foreign language script translators.

Embodiments of the invention may provide various benefits that may include eliminating duplication of effort by multiple users (i.e., for dubbing), ensuring the acquisition of edited content by media content owners, speeding access to edited content by allowing the user to make edits and download the reduced file instead of downloading digital end-to-end workflows even with custom tasks such as editing and localization, and restricting the release of premium content to clip level only.

### BRIEF DESCRIPTION OF THE DRAWINGS

Referring now to the drawings in which like reference numbers represent corresponding parts throughout:

FIG. 1 schematically illustrates a hardware and software environment in accordance with one or more embodiments of the invention;

FIG. 2 illustrates an integrated digital distribution system suite that enables such management and distribution in accordance with one or more embodiments of the invention;

FIG. 3 is a flow chart illustrating a typical user process for editing media content in accordance with one or more embodiments of the invention;

FIG. 4 is a flow chart illustrating the flow for the submission management workflow in accordance with one or more embodiments of the invention;

FIG. 5 illustrates an Edit Bay submissions view in accordance with one or more embodiments of the invention;

FIG. 6 illustrates a pop-up window that is displayed when a servicing personnel clicks on a reference ID link/number in the window of FIG. 5 in order to add optional purchase order numbers and/or priority information for a given item in accordance with one or more embodiments of the invention;

FIG. 7 illustrates a dialog box displayed that provides the ability for the servicing personnel to download the localization submission provided by a user/dubber in accordance with one or more embodiments of the invention;

FIG. 8 illustrates an edit queue displayed in accordance with one or more embodiments of the invention;

FIG. 9 illustrates a window/user interface of an editor application used to create and update localized text entries in accordance with one or more embodiments of the invention;

FIG. 10 illustrates a promotional clip module with a selected video loaded in accordance with one or more embodiments of the invention;

FIG. 11 illustrates edit details of a promotional clip in accordance with one or more embodiments of the invention;

FIG. 12 illustrates the interaction between the different modules that may be used to create a promotional clip in accordance with one or more embodiments of the invention; and

FIG. 13 illustrates a summary of the promotional clip workflow in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Embodiments of the invention provide an online language localization portal that allows users (e.g., licensees or vendors) to input/enter localized text information into an application and submit the collected text entries to a media content owner. In addition, the portal is an integrated part of a secure digital file-based media content delivery system.

### Hardware Environment

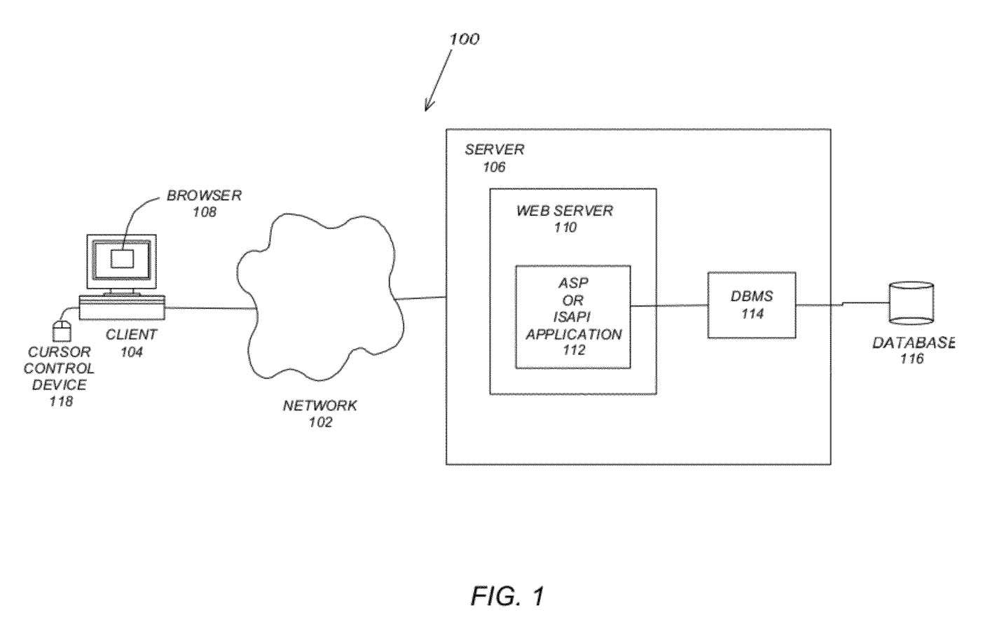

FIG. 1 schematically illustrates a hardware and software environment in accordance with one or more embodiments of the invention, and more particularly, illustrates a typical distributed computer system 100 using a network 102 to connect client(s) 104 (also referred to as client computers) to server(s) 106 (also referred to as server computers). A typical combination of resources may include a network 102 comprising the Internet, LANs (local area networks), WANs (wide area networks), SNA (systems network architecture) networks, or the like, clients 104 that are personal computers or workstations, and servers 106 that are personal computers, workstations, minicomputers, or mainframes. Additionally, both client 104 and server 106 may receive input (e.g., cursor location input) and display a cursor in response to an input device such as cursor control device 118.

A network 102 such as the Internet connects clients 104 to servers 106. Network 102 may utilize ethernet, coaxial cable, wireless communications, radio frequency (RF), etc. to connect and provide the communication between clients 104 and servers 106. Clients 104 may execute a client application or web browser 108 and communicate with servers 106 executing web servers 110. Such a web browser 108 is typically a program such as MICROSOFT INTERNET EXPLORER™, MOZILLA FIREFOX™, OPERA™, or APPLE SAFARI™. Further, the software executing on clients 104 may be downloaded from server computer 106 to client computers 104 and installed as a plug in or ACTIVEX™ control of a web browser. Accordingly, clients 104 may utilize ACTIVEX™ components/component object model (COM) or distributed COM (DCOM) components to provide a user interface on a display of client 104. The web server 110 is typically a program such as MICROSOFT'S INTERNENT INFORMATION SERVER™

Web server 110 may host an Active Server Page (ASP) or Internet Server Application Programming Interface (ISAPI) application 112, which may be executing scripts. The scripts invoke objects that execute business logic (referred to as business objects). The business objects then manipulate data in database 116 through a database management system (DBMS) 114. Alternatively, database 116 may be part of or connected directly to client 104 instead of communicating/obtaining the information from database 116 across network 102. When a developer encapsulates the business functionality into objects, the system may be referred to as a component object model (COM) system. Accordingly, the scripts executing on web server 110 (and/or application 112) invoke COM objects that implement the business logic. Further, server 106 may utilize MICROSOFT'S™ Transaction Server (MTS) to access required data stored in database 116 via an interface such as ADO (Active Data Objects), OLE DB (Object Linking and Embedding DataBase), or ODBC (Open DataBase Connectivity). In addition, development in any of the components 104-118 may be performed using Silverlight™ (available from Microsoft™) or other development platform.

Additionally, the web server 110 may provide web services that are used by client 104. Web Services Business Process Execution Language (WS-BPEL) or BPEL for short, is a standard executable language (defined by OASIS™—the Organization for the Advancement of Structured Information Standards—a consortium that publishes/hosts open standards for various web-based applications) used for specifying actions within business processes with web services. Processes in PBEL export and import information by using web service interfaces.

Generally, these components 108-118 all comprise logic and/or data that is embodied in or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

In one embodiment, instructions implementing the browser 108 or other applications for either client 104 or server 106 are tangibly embodied in a computer-readable medium, e.g., data storage device, which could include one or more fixed or removable data storage devices, such as a zip drive, floppy disc drive, hard drive, CD-ROM drive, tape drive, etc. Further, such applications are comprised of computer program instructions which, when accessed, read and executed by the client 104 or server 106 causes such computers 104-106 to perform the steps necessary to implement and/or use the present invention or to load the program of instructions into a memory, thus creating a special purpose data structure causing the computer to operate as a specially programmed computer executing the method steps described herein. Such applications may also be tangibly embodied in memory and/or data communications devices, thereby making a computer program product or article of manufacture according to the invention. As such, the terms “article of manufacture,” “program storage device” and “computer program product” as used herein are intended to encompass a computer program accessible from any computer readable device or media.

Although the term “user computer”, “client computer”, and/or “server computer” is referred to herein, it is understood that such computers 104-106 may include portable devices such as cell phones, notebook computers, pocket computers, or any other device with suitable processing, communication, and input/output capability.

Of course, those skilled in the art will recognize that any combination of the above components, or any number of different components, peripherals, and other devices, may be used with computers 104-106.

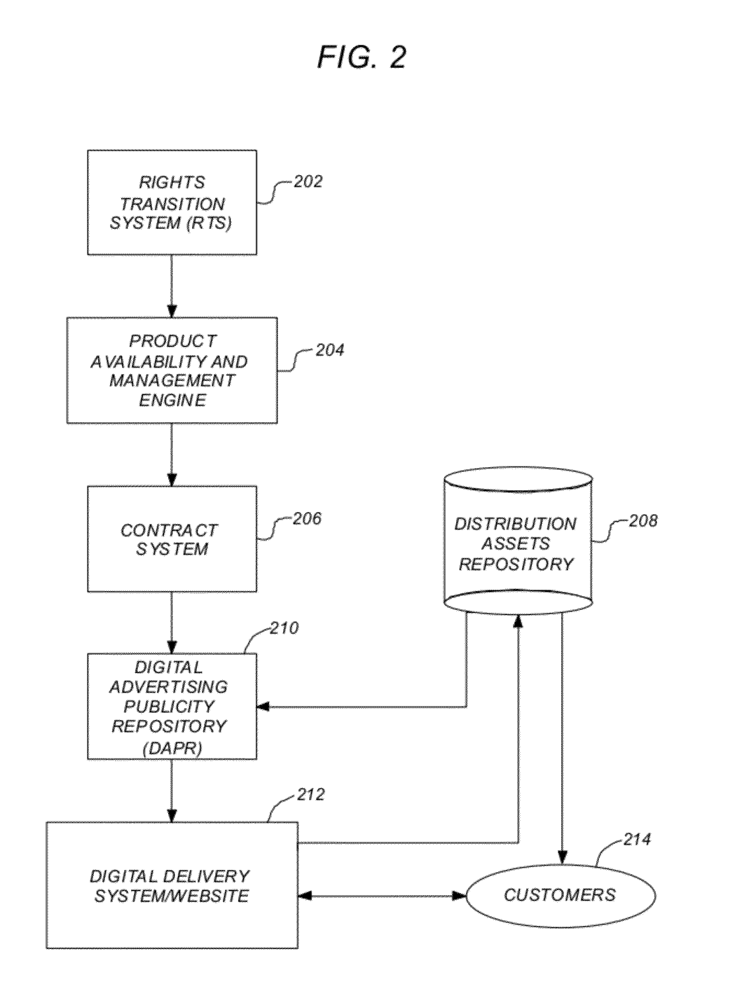

Using the network architecture of FIG. 1, embodiments of the invention may further integrate multiple different systems to provide for the secure management of the digital distribution of media content. FIG. 2 illustrates an integrated digital distribution system suite that enables such management and distribution. Each of the systems and components of FIG. 2 may be implemented by either a client computer 104 or server computer 106 to provide the features described herein.

A custom built repository, referred to as a rights transition system (RTS) 202) manages content and distribution rights. RTS 202 is the foundation of product status feeding downstream systems with information related to distribution rights, media, territory, language, and music rights. In other words, the RTS 202 identifies the ownership rights (i.e., distribution and licensed rights) that are available. Such information includes what one is allowed to do with the product (e.g., if one has any rights to give away/license with respect to a particular product).

The information in RTS 202 may be transmitted or retrieved using a product availability and management engine 204. In other words, product availability and management engine 204 provides the ability to query RTS 202 to retrieve details regarding sales/licensing information. For example, engine 204 may provide information regarding what products are available to sell/license, where the product may be sold/licensed, what media may be sold/licensed, when the product may be sold/licensed, and how long the product may be sold/licensed (e.g., the availability date of every film before 1975 in German). Accordingly, engine 204 may also be known as a recording and reporting engine that provides the ability to query RTS 202 for data to determine available products/content.

Contract system 206 retrieves (or is transmitted) information from product availability and management engine 204. Contract system 206 records details regarding the specific completed transactions/licenses with customers. In other words, the licensed rights such as an identification of a particular product, the time period of the license, and the specific customers part of that license are recorded within contract system 206. For example, all licenses for a television program such as GLEE™ may be recorded within contract system 206. For all such licenses, a user may be given access based thereon. When a new episode of GLEE™ is uploaded, access may be automatically generated based on such recorded licenses (without the need to resubmit or update the license provisions recorded within contract system 206). In addition, any billing to customers for such licensed rights may occur within contract system 206.

The distribution assets repository 208 (also known as ESPIRIT™) is a custom built system designed as a studio's repository for distribution assets including full length broadcast video, promotional material, and marketing material. In other words, repository 208 provides a distribution warehouse for product deliverables (i.e., digital downloads for a product). File acceleration software may be used within repository 208 to expedite the delivery of products to customers. Alternatively, broadcast video assets may be stored in repository 208 while marketing and screener assets may be stored in a repository within the digital advertising publicity repository (DAPR) 210. Referring to FIGS. 1 and 2, such a repository 208 may be represented by database 116 that interfaces with a DBMS 114 and/or a BPEL web service via web server 106 to clients 104/customers 214.

The DAPR 210 is a custom application that feeds (to customers) contractual licensing and product information from upstream sales applications. DAPR 210 is the “air traffic control” mechanism of the digital delivery initiative described herein and allows users/administrators to define/set conditional-based access policies for all file-based distribution assets. Security controls for products/assets may be further established/defined/modified in DAPR 210. In other words, based on the licensed rights from upstream applications 202-208, DAPR 210 provides an administrator with the capability to determine how customers 214 or users can view and select products/content from a digital delivery system/website 212. Information from the upstream applications 202-208 may be pushed into the DAPR system 210 on a regular/semi-regular basis to ensure appropriate security access controls are being utilized. While the different licensed rights information is determined in systems 202-206, the actual downloadable assets are stored in repository 208 and DAPR 210 controls the security mechanisms (i.e., who has appropriate access/download privileges) to determine whether a customer 214 on a delivery system/website 212 can download the assets in/from repository 208.

DAPR system 210 further provides the ability to view, manage, and work with any dubbing edits submitted by users viewing the digital delivery system website 212 (or a portion of the website available for conducting edits).

Digital delivery system/website 212 is a business-to-business online portal designed to deliver all file-based assets connected to the sales, promotion and broadcast of television distribution licensed properties. In other words, the website 212 is the storefront for the electronic delivery of professional grade product deliverables and editing.

### Software Embodiment Overview

Through the above described systems and components of FIG. 1 and FIG. 2, a digital delivery system 212 (that may include a website or a network accessible application) provides a secure, encrypted and easy to use file-based delivery solution to receive video assets. The system 212 provides a central access hub for licensees to source all video assets required for content acquisition decisions, promotions, and broadcast. In this regard, preview video streamed through the system 212 can replace DVD screeners while broadcast video accessed via system 212 replaces videotape.

The system 212 provides/combines three different sites/functions into a single system/application: (1) a public site catalog; (2) marketing assets system; and (3) a screening and download system. An overview of each functions will be described followed by detailed descriptions of the user interface features of embodiments of the invention.

The public site catalog provides a non-password protected area for pre-sales information to be searched. All content available can be viewed to assist a customer in evaluating content as part of the purchase decision. As part of the catalog, digital posters may be displayed with content information. By hovering over a poster with a cursor, an enlarged view may be displayed, that upon activation, provides an overview of the product/property associated with the poster that may include cast or other publicly available information. Low resolution photographs, public trailers, and other publicly accessible material may be available in this portion of the system 212.

The marketing assets system is available to authorized users via login and password. The information in the marketing assets system provides information based on the particular license associated with the authorized user. In other words, the assets that can be viewed may reflect the licensed rights from contract system 206 based on the security parameters set forth in DAPR 210. Accordingly, when an asset has been licensed, the content owner (e.g., sales representative from the content owner) enters the license terms into the back-end system (e.g., contract system 206), and such assets are reflected in the logged-in area of system 212.

The screening and download system may be viewed by customers 214 once logged in (e.g., via username and password). In this system, the authorized customer 214 can view items available for download and screening. The screening capability allows users 214 to preview video content using a graphically rich user interface as described herein. Further, the screening capabilities may be configured for multi-party viewing, via a television, or through a mobile device. Such screening and downloading capabilities may include assets such as full length video, audio elements, photography, scripts, music cue sheets, on-air promos, etc. In addition to traditional marketing assets, authorized customers 214 may have the ability to retrieve/download intellectual property (including a technical data transfer) associated with an asset/show/concept. Such distribution is referred to as a format title asset distribution. For example, the idea/concept for a reality show (e.g., Beauty and the Geek™) may be sold to a customer 214 in a different country and the screening/download system provides the ability to transfer the concepts, set design, blue prints, etc. for the idea/concept to the authorized customer 214.

In addition, the screening and download area provides a unique user interface, indicating content available for download and screening, for every authorized customer 214 based on what that customer 214 has licensed. Further, such downloadable content may be DRM-protected.

### Workflow Overview

The digital delivery system/website 212 provides a user interface that allows users/customers/dubbers 214 to enter localized text information and submit the collected text entries to a media content owner for further processing (e.g., to conduct the editing based on the collected text entries).

User Workflow

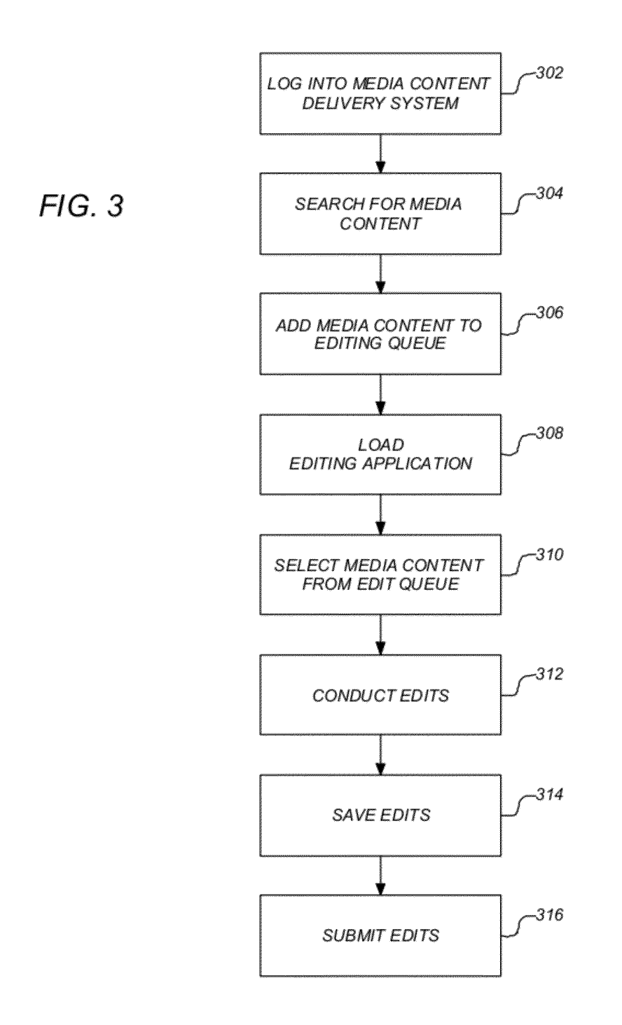

For the integration with system 212 (and components 202-214), the typical user process may proceed as indicated in FIG. 3. At step 302, the user/customer 214 logs into the media content delivery system 212.

At step 304, the user/customer 214 searches for media content (e.g., a video) to operate against (e.g., via components 202-210 which are an integrated part of the delivery system 212).

At step 306, the user/customer 214 adds the desired/selected media content to an edit queue from within system 212.

At step 308, the user/customer 214 loads the editing application from website/system 212 (e.g., by clicking a link to the editing/dubbing application). As used herein, such an application or area of the website 212 may be referred to as EDIT BAY™. Such a selection may load the editing application in a pop-up window or dialog box within system 212 (e.g., as part of an applet). In the loaded application, the user/customer 214 can view a list of all of the media content/videos in the user's edit queue.

At step 310, the user/customer 214 selects one media content asset (e.g., video) to conduct the editing on.

At step 312, the user/customer 214 conducts the necessary edits (e.g., by inserting the appropriate text as described in further detail below).

At step 314, the user/customer 214 saves the edits as they are created. The user/customer 214 can return for more edits at a later date without losing previously created edits.

Once editing is complete, a user/customer 214 with appropriate authorization (e.g., “submit” permission) can submit the completed edits/file to the media content owner. Before or after a submission is made, the localization/edits can be shared with other authorized users.

Submission Management Workflow

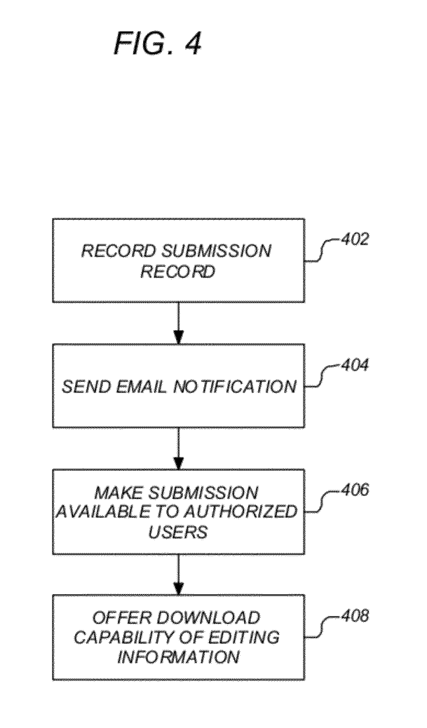

In coordination with the user workflow described above, once submitted, the system 212 may perform various tasks. FIG. 4 is a flow chart illustrating the flow for the submission management workflow in accordance with one or more embodiments of the invention.

Once the user submits their localization edits at step 316, the system performs the steps of FIG. 4. At step 402 a submission record is added to an edit processing queue within DAPR 210. The submission record is labeled with a status of “new”.

At step 404, an email notification is sent to both a particular servicing personnel (e.g., a material requestor and servicing coordinator per the submitter's assigned group) and to a group of users (e.g., media service users) indicating that a new submission has been added to the queue.

At step 406, the submission becomes available to the servicing personnel and to the media service personnel immediately upon the user's “submit” action at step 316. Additionally, the servicing personnel may have the option to access the edit queue in DAPR 210 to add a purchase order (P.O.) number and/or denote the request as a high priority.

At step 408, media service personnel can access the queue within DAPR 210 and download a file containing the localization/editing information. This action, by the media services personnel, sets the status of the item to “downloaded”.

Workflow and Permissions Requirements

Customers/users 214 may have permission to see a new action icon per screener video assets within the digital delivery system/website 212 that allows the video to be added to the customer's 214 own edit queue. For these customers 214, an edit queue link may be added to system/website 212 to allow the user access to their queue. (The user's 214 personal edit queue listing may be displayed using an editing tool offered on the website or in a separate application (e.g., plug-in, applet, etc.) via the website 212).

New additive permissions may be available from a user management edit screen within DAPR 210. Users can be granted access to the editing application when DAPR 210 or other administrators check one or more of the three new flags on the user's user management edit screen in DAPR 210. The different flags may represent access permissions to review a localization, edit a localization, and/or submit a localization.

Permissions for localization review may add an Edit Bay link in the system/website 212 displayed to the user 214. Since review only permission does not grant the capability to actually conduct any edits, an “add to Edit Bay” queue icons per identified video assets may not be available and some timeline controls within the Edit Bay application may be disabled. A queue listing is available in a user's 214 individual Edit Bay (tracking any localizations that have been shared with them). Sharing/forwarding via e-mail of any localization effort in a user's 212 queue is possible.

Permissions for localization edit may add an “add to Edit Bay” queue icon for select media content/videos in the localization editing controls that are available to a user 214. By granting localization editing permission, a user 214 can create and save edits but cannot submit them. This type of user 214 can also generate a link to his/her edits that can be shared via email with other users 214 who have Edit Bay permissions. Editors may not be granted permission to further edit localizations created by other editors.

‘Localization-Submit’ permissions enable the addition of a “submit button” within the Edit Bay application. Examples of users 214 that may have submission permission may include dubbers, editors, and/or administrators (e.g., in a local geographic area).

The capability to add, edit, and/or change the flags for the permissions for localization-review, localization-edit, and localization-submit may be granted to a servicing manager within the DAPR 210 system. In addition, DAPR 210 super user membership may enable such an administrator to operate the flags.

A DAPR 210 client-side script may also require a ‘Review’ checkbox be checked to enable selection of the ‘Edit’ and/or ‘Submit’ checkboxes.

In addition to the above, a new ‘Localization Submissions’ menu item may be added to DAPR 210 that is accessible to DAPR admin users belonging to either one of the following two new DAPR administrator groups: “Edit Bay-Servicing”, and/or “Edit Bay-FMS”. The servicing administrator group commonly includes users that can monitor submissions. The Edit Bay-FMS groups commonly includes users that will receive submissions and leverage the data received. Further, a new ‘Edit Bay Localization Submissions’ view may be available to members of the above-noted administrator groups and will list all submissions and their current status. Such a view may include a search header and/or a submission queue.

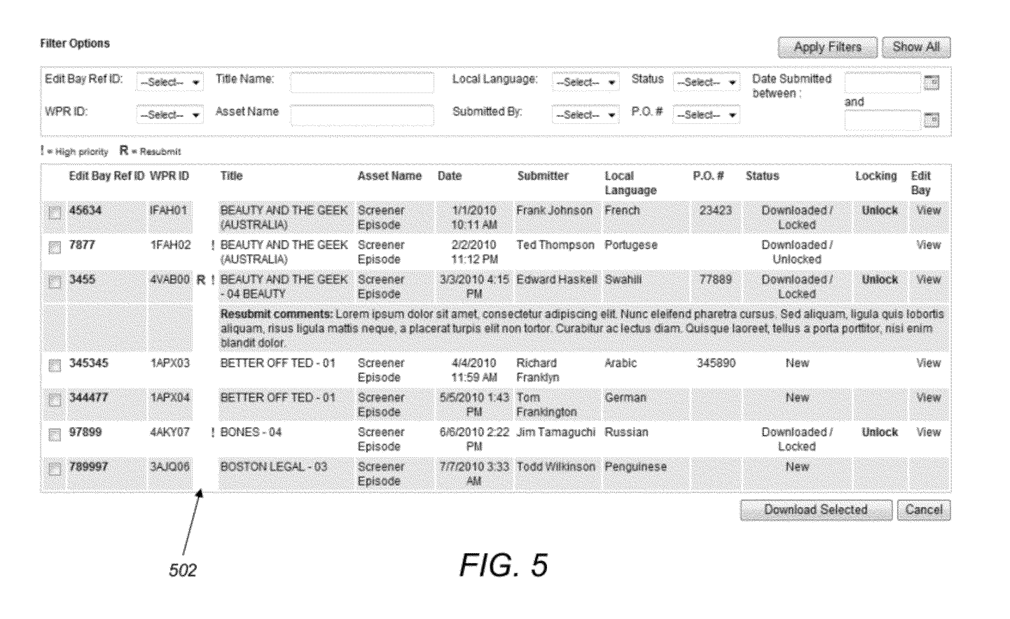

The search/filter header is a section above the submission list that allows the user to reduce the number of items displayed in the submission list by providing a set of search criteria. Only items that match the search criteria will be displayed in the list. The search criteria may consist of dropdowns and text fields. The dropdowns will contain a list of all the unique values in the full list for a given item. FIG. 5 illustrates an Edit Bay submissions view having search criteria for filtering a list in accordance with one or more embodiments of the invention. The different rows illustrate the different edits/localizations submitted by users 214 as viewed from the DAPR 210.

As illustrated in FIG. 5, the available search fields may include:
i. Edit Bay Ref ID—Text input field
ii. WPR (World Product Registry) ID—Text input field
iii. Title Name—Text input field
iv. Asset Name—Text input field
v. Local Language—Dropdown
vi. Submitted By—Dropdown
vii. P.O. #—Text input field
viii. Date Submitted—Two text fields for entering a date range.

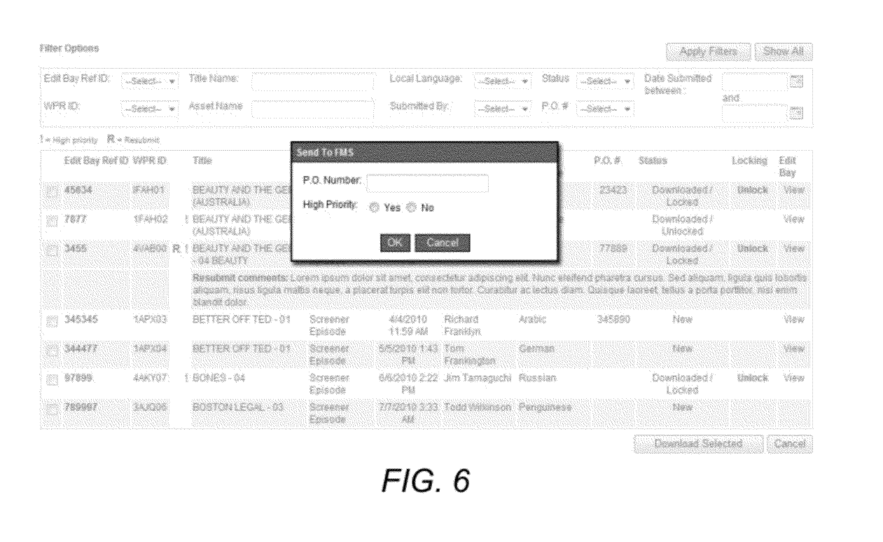

The submission list/queue represents each submission in a separate row. Sorting will be available on all columns by clicking the column header. Each row item may contain the following columns:

| Column | | |
|---|---|---|
| Header/Name | Type | Notes |
| Edit Bay | INTEGER | Numeric display - but active/clickable to |
| Reference ID | | allow edit of record by DAPR admin |
| | | users belonging to ‘Edit Bay - Servicing’ |
| | | admin group. |
| | | When this link is clicked, a popup will |
| | | appear (see FIG. 6) that allows the user to |
| | | enter a P.O. number and/or indicate that |
| | | this submission is a high priority. |
| | | Clicking “Cancel” dismisses the popup |
| | | and no changes are made. |
| WPR ID | CHAR | WPR ID of the WPR Title that the video |
| | | asset is associated with. |
| Priority flag | YES/NO | a “!” (FIG. 5) will appear in this column if |
| | | the item has been designated as a high |
| | | priority item. |
| Resubmit flag | YES/NO | an “R” (FIG. 5) will appear in this |
| | | column if this item has been resubmitted. |
| Resubmit | CHAR | Appears only if an item has been |
| Comments | | resubmitted and comments have been |
| | | included by the Edit Bay user. |
| Title | CHAR | FoxFast ™ Title (99% of time = WPR |
| | | Title, else TVD Alias Title) that video |
| | | asset is associated to in FoxFast ™. |
| Asset Name | CHAR | DAPR/Fast ‘Asset Name’ of video. |
| Date Submitted | DATE | date and time of submission from Edit |
| | | Bay user. |
| Submitter Name | CHAR | FoxFast ™ username of Edit Bay |
| Localization | LOOKUP | |
| Language | | |
| P.O. # | INTEGER | |
| Status | CHAR | “New” or “Downloaded”/“Locked” or |
| | | “Unlocked” |
| Locking | {Control} | A clickable link per downloaded/locked |
| | | record that unlocks the edit request |
| Download | {Control} | a checkbox, per record, allowing the |
| checkbox column | | marking of a submission for download. |
| Edit Bay ‘View’ | URL Link | a clickable icon per record that loads the |
| | | Localization into your Edit Bay |

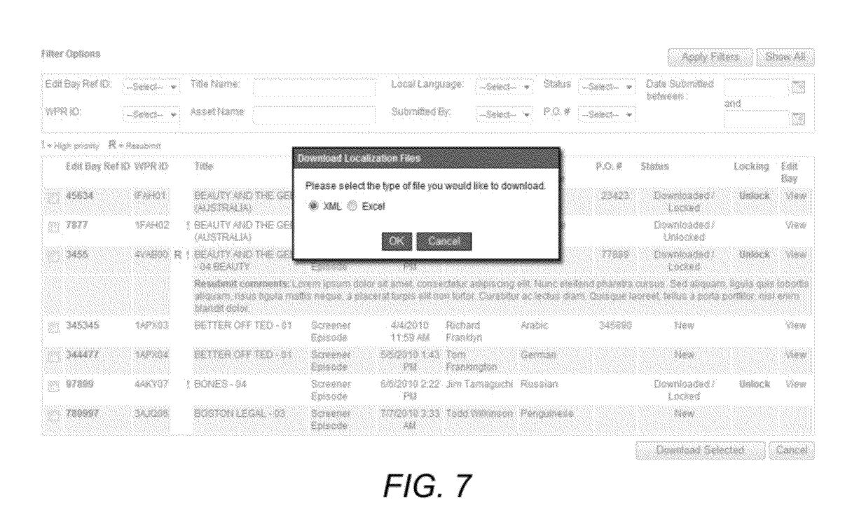

In addition, a ‘Download Selected’ button may be available to allow the user to download the selected submission(s). Such a button may be enabled where a pop-up will permit the user to select either an XML (extensible markup language) or spreadsheet based version (e.g., Excel™) of the submission(s) (see FIG. 7); and/or when a submission is downloaded by a DAPR 210 user belonging to ‘Edit Bay-FMS’, the status of the submission record may change to “Downloaded”.

Additionally, DAPR ‘Edit Bay-Servicing’ users are permitted to download any/all submissions—but this may not change the status of the submission record.

FIG. 6 illustrates a pop-up window that is displayed when a servicing personnel clicks on a reference ID link/number in the window of FIG. 5 in order to add optional purchase order numbers and/or priority information for a given item in accordance with one or more embodiments of the invention.

FIG. 7 illustrates a dialog box that enables the servicing personnel or DAPR 210 user to download the localization submission provided by a user/dubber 214 in accordance with one or more embodiments of the invention. In the example illustrated, either an XML (extensible markup language) or Excel™ (spreadsheet) file may be downloaded. Other file types may also be offered in accordance with embodiments of the invention.

### User Tool for Localization Text Entry and Submissions

Edit Queue

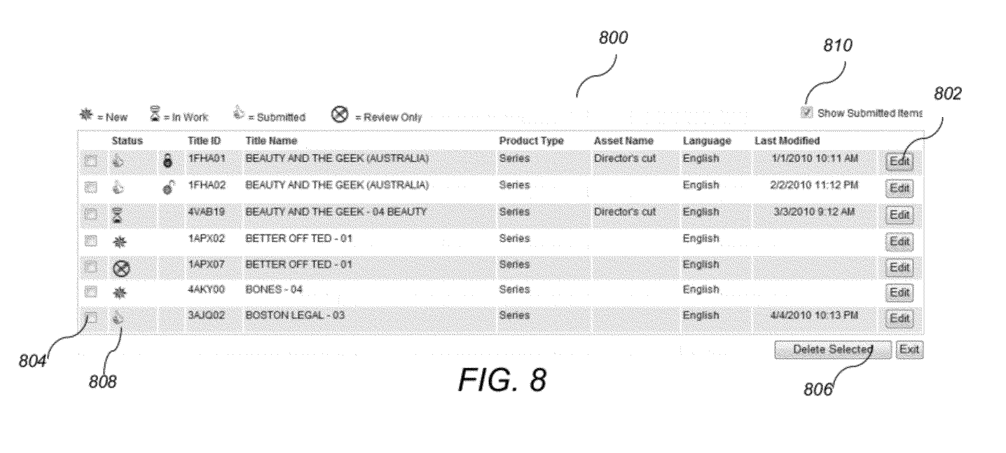

When the Edit Bay application is first loaded, the user 214 will see a list of all the items in his Edit Queue (FIG. 8). Sorting will be available on all columns by clicking the column header. To begin editing an item the user 214 will click the edit button 802 next to the item he wants to edit. To remove items from the queue, the user 214 will take the following actions:

Check the checkboxes 804 next to the item(s) he wishes to remove;

Click the “Delete Selected” button 806 in the controls section;

The system will alert the user 214 to confirm the deletion; and

If the user 214 confirms the deletion, the items will be removed from the queue.

Alternatively, instead of the “edit button 802, the button may be replaced with a dropdown that contains the links to each of three different modules—(1) localization; (2) promo clip; and (3) censorship. When one of the three links is selected, the corresponding module is loaded with the selected files ready to edit. A fourth menu option may further permit the user to extract stills.

The possible status values are displayed (e.g., using representative icons) in column 808 may include New (e.g., an asterisk or star), Work-in-progress (e.g., a sand timer), submitted (e.g., a thumbs-up), and/or review only (e.g., a pencil in a circle with a diagonal line/x drawn through/over it). By hovering with the cursor over a particular icon, a textual “tip” may display indicating the above status values. A new item is an item that has not been modified since being added to the edit queue. A work-in-progress status is the initial status of an item once the user 214 has begun editing it but has not yet been submitted. A submitted status indicates a localization that has been submitted by the user/dubber 214. A review only status indicates an item has been received via a ‘Share’ URL (uniform resource locator) Link from another user 214. Such a localization cannot be edited but can be reviewed—playback only.

In addition, a number may be displayed in the edit bay queue view 800 that represents the number of items displayed in the list. The number may reflect only what is displayed. For example, when the user un-checks the “Show Submitted Items” check box 810, the number may only show the number of un-submitted items left in the list.

Playback and Edit Mode Screen Layout

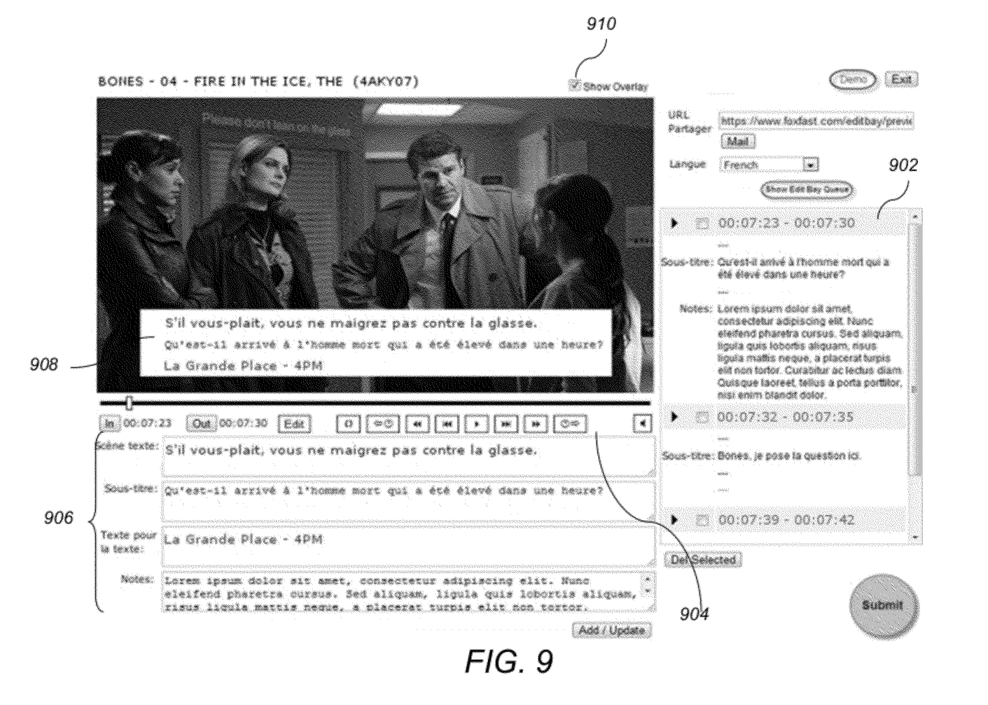

Referring to FIG. 9, upon clicking ‘Edit’ on an item in the edit queue, the user 214 arrives to an editing screen (also referred to as “Edit Bay screen”) that consists of video and playback controls, a user entry area, time in/out markers, a sharing link field, a language selector, localized text listing, a controls section, and a navigation section.

The video and playback controls area displays the name of the video/media content being edited, the actual video/media content available for playback/review, and the video/media content controls. The controls may include an edit button, a loop button, a back one second button, a previous edit button, a play/pause button, a next edit button, a forward one second button, a volume control button, and a scrub bar.

The edit button is used to enter “Mark-Up Mode”.

Selection of the loop button the first time causes the current timecode segment (defined by the In/Out markers) to loop continuously. Selecting the loop button again cancels looping and returns to normal playback.

The back one (1) second button skips backwards one (1) second from the current location.

The Previous Edit button skips to the previous milestone, the beginning of the current segment or the end of the previous segment.

The Play/Pause button changes functions depending on the current state. While the video is playing the button acts as a pause button; while paused, a play button. It also acts to restore playback speed to 1×.

The Next Edit button skips to the next milestone, the end of the current segment or the beginning of the next segment.

The Forward one (1) second button skips forward one (1) second from the current location.

The Volume control button allows the user 214 to change the volume of the video.

The Scrub Bar allows the user 214 to access any section of the video along the timeline.

The User Entry area contains the controls the user 214 will use to perform the editing. The text fields will be used by the user 214 to enter forced subtitles, subtitles, texted shot, and comments text. The “Add” button, when clicked, will add the edit text item(s) to the list of edits.

The Time In/Out markers area provides two (2) buttons that allow the user 214 to define the time parameters of each edit item. Using the play controls and/or the scrub bar, the user 214 will navigate to the desired section of the video that will be the beginning of the timecode segment then click on the “Mark time in” button. This will define the beginning of the segment. The user 214 then navigates to the desired section of the video that will be the end of the segment and click the “Mark time out” button to define the end. These two actions define the entire timecode segment.

The Sharing Link area can be used to share edits with other users. The contents of the text field can be copied and pasted into an email message, an instant message (IM), etc. A ‘Mail It’ button will launch the user's default mail application with the link noted in the body of the message. In some embodiments, only the originator of the localization effort can make edits. Localizations that are shared may not be editable by the user receiving the Shared Link—it is only reviewable/only available for playback.

In the language selector area, the user 214 uses a dropdown selector (or other selection technique) to choose the local language of the subtitles. This selection will apply to all the localized text entries for the asset. For select languages (French, Spanish, Italian, Latin Spanish, etc.) this value will dictate the localized language labels within the user's tool/screen. In other words, this field identifies the language of the text entries that the user 214 submits.

The Localized Text listing area provides a list of any and all localized text entries, per timecode segment, the user has added to the asset.

The Controls section contains the controls that allow the user 214 to manage edits, submit, etc. The controls section may include:

a Submit button—Allows the user to submit the edits;

a Delete Selected button—Allows the user to delete edits he/she has already created; and

an Exit button—allows the user to quit the Edit Bay and return to FoxFast (or to the parent application).

A Navigation section allows the user to move/navigate to their edit queue.

### Creating and Updating Localized Text Entries

FIG. 9 illustrates a window/user interface of an editor application used to create an update localized text entries in accordance with one or more embodiments of the invention.

If a video that is loaded has existing edits from a previous session, they are loaded and displayed in the edit list 902 on the right side of the screen. If no edits exist then the edits list 902 will be empty.

The Video Playback controls 904 provide the ability to play, fast forward, etc. the video/media content (see the description above).

User edits may be displayed in various areas. In this regard, during playback of the video or when the user navigates to any part of the video, the system will display any user edits that apply to the current video time segment both in the user text entry boxes 906 and overlaid 908 on the video playback screen (if the ‘Show Overlays’ checkbox 910 is checked). The three different types of localization text entries may appear in different colors when overlaid on the video. For example, if a user creates a subtitle from 1:45:17 to 1:45:25 then during playback, when the video reaches 1:45:17, the user-entered subtitle may be displayed in the appropriate text entry field 906 (Subtitle, texted shot or forced subtitle) over the video playback.

The user entry controls 906 provide various fields for user entry. The subtitle text area is a text entry field to allow the user to enter the local language translation of the English or other specified language dialog.

The Texted Shot—Text area field is a text entry field that allows the user to enter the local language translation of any English (or other selected language) text that is displayed such as the name of a location, or time of day, etc.

The Forced subtitle—Text area is a text entry field that allows the user to enter the local language translation of any English (or other selected language) text that may appear in the scene such as text on a magazine or billboard.

The Comment—Text area is a text entry field that allows the user to enter a general comment he/she wishes to attach to the edit item.

The Add/Update button enables the user to either add a new edit to the edits list or save changes made to an edit list item that is being modified.

The process for adding and/or updating a localized text segment may follow one or more of the following steps.

To add a new text entry, the user will locate the start of the desired time segment by using the video playback controls and marking the “In” time by clicking the “In” button. Once the “In” marker has been set, the user will be placed in ‘Edit Mode’ as indicated by a red (or other distinguishable identifier) border around the video section. The user will then locate the end of the time segment and mark the “Out” time by clicking the “Out” button. The user can change the In/Out markers by moving to a different time in the video (e.g., using the marker in the timeline or the video playback controls) and clicking the In or Out button again, this will overwrite the previous time marker with the new one.

Once the time segment has been defined by the In and Out times, the user can enter the desired entries in the text boxes and click the “Add/Update” button. This will record the edit item and exit Edit Mode.

An existing text entry segment can be edited by the user moving the video to a time that is within the time limits of the segment he/she wishes to edit, and selecting/clicking the Edit button. For example, if the segment to edit is from 14:22 to 14:37, the user can move the video to 14:25 and click the Edit button to begin editing the segment. The user will be placed in Edit mode and can change the subtitles or the In/Out markers of the segment. Once the editing is finished, the user can click the “Add/Update” button to record the changes.

In one or more embodiments, Text Entry Segments may not overlap each other along the timeline. For example, if a segment exists between 14:22 and 14:37, no other segment can begin or end within this time span. However, in alternative embodiments, overlaps may be permitted. Below are some examples for how this restriction affects the editing process:

A segment exists from 3:03 to 3:45. During playback, the “In/Out” buttons are disabled BUT the “Edit Mode” button is enabled while the video is in this time period. This means the user can edit the segment but cannot create a new one. Once the “Edit” button is clicked and the user is in Edit Mode, the “In/Out” buttons are enabled to allow the user to change the time markers of the segment being edited.

A segment exists from 3:03 to 3:45. During playback, the “In/Out” buttons are disabled and the “Edit” button is enabled while the video is in this time period. Once the video has reached 3:46 (one second past the end of the existing segment) the “In/Out” buttons will be enabled and the “Edit” button disabled. This means the user can create a new segment. Once the user clicks the “In” button to mark the start of the segment, he is placed in edit mode and is now restricted to a reduced timeline that starts at 3:46 and ends at the end of the video. The user may not be permitted to move backwards in the timeline beyond 3:46.

A segment exists from 3:03 to 3:45 and another from 4:30 to 5:00. During playback, the “In/Out” buttons are disabled and the “Edit” button is enabled while the video is between 3:03 and 3:45. Once the video has reached 3:46 (one second past the end of the existing segment) the “In/Out” buttons will be enabled and the “Edit” button disabled. Now the user can create a new segment. Assuming the user clicks the “In” button to mark the start of the segment at 3:55, he is placed in edit mode and is now restricted to a reduced timeline that starts at 3:46 (one second after the end of the previous segment) and ends at 4:29 (one second before the beginning of the next segment). The user cannot move backwards in the timeline beyond 3:46 and cannot move forwards beyond 4:29.

The Edits list section 902 displays a list of all the edits that have been added to the current asset. Each item will display several pieces of information related to each edit. They are as follows:

The In and Out time;

Local language subtitles;

Local language forced subtitle;

Local language texted shot subtitle;

User comments;

A link to allow the user to move the video directly to the start time of the edit, display all the user entered subtitles and comments in their respected text input boxes and overlaid on the video screen, and begin playback of the video; and

A checkbox used to delete one or more edit items.

The Toggle Overlays checkbox 910 allows the user to choose whether or not to show the subtitles overlaid on the video (e.g., in field 908).

Once submitted, an output file may be made available for download (e.g., step 406 of FIG. 4). The output file should contain the following Header information:

Edit Bay Reference ID number;

WPR Title that the video asset is related to;

WPR ID for the above-noted Title;

Asset Name;

Localized Language;

Date and time the user submitted the request;

Name of Edit Bay user who made the submission; and

E-Mail address of Edit Bay user.

Following the Header, entries for each segment may include:

Time in (H:MM:SS);

Time Out (H:MM:SS);

Type (subtitle, texted shot, or forced subtitle);

Local language subtitle; and

Comment.

After a submission has been made from the editing application, it can be submitted again as many times as is necessary to allow for addition, deletion or correction of subtitles. Each subsequent submission will overwrite the previous one and the system will not maintain the older version. This is the case as long as the edit request has not been downloaded by media services personnel.

Once the edit request has been downloaded by media services personnel (e.g., those persons responsible for conducting the actual edits), the item will be locked and no further submissions can be made unless the media services personnel unlock it. When a user tries to submit an edit request that has been locked, he/she will be presented with a warning dialog informing him that the request is locked and cannot be resubmitted, and that he must submit a request to the media services/administrator in order to unlock it. The dialog may also give a yes/no choice to allow the user to send the unlock request.

If the user chooses to submit the request to unlock, the system will launch a new email message using the user's email application. The “To:” field of the message will be pre-populated with the recipient address (e.g., a default media services personnel address) and the body of the message will have the edit bay reference ID and title of the asset. The user would be free to add any additional text to the body of the message. All additional communication regarding unlocking the edit request will take place outside the Edit Bay application.

To unlock an edit request, media services personnel will access the DAPR queue. Any edit request that has been downloaded and is locked will have a link associated with it that allows it to be unlocked. Once the edit request has been unlocked, the user's edit queue will reflect this by displaying the appropriate icon.

When the user attempts to overwrite an existing edit request that has been unlocked, the system will prompt the user to confirm the re-submission and will allow the user to enter a comment relating to the re-submission. When an overwrite request is submitted, the Edit Bay Submission queue will:

Reset the status of the request to “New” in the Submission queue;

Send an email notification to servicing personnel (e.g., material requestor and servicing coordinator per a submitter's group/privileges) informing them of the re-submission; and

An email notification is also sent to all media services personnel informing them of the re-submission.

A Dubbing Card credits section may be utilized once a user clicks the submit button (i.e., at step 316 of FIG. 3). Such a section may present the user with a form to populate in order to identify credit to be granted for the localization effort.

### Additional Edit Bay Features

In addition to the above, the Edit Bay application may enable the user with the options to perform censorship edits, create a promotional clip (e.g., by specifying/extracting short video segments from multiple source files to be joined/mashed together), a transcription and annotation tool, and/or single image or clip (i.e., multiple images) capture capabilities for high resolution stills/clips from broadcast quality video. In this regard, a single web portal/application enables users to not only view/download media content but to also enter textual data, perform censorship edits (to enable availability for audiences of all ages), create promotional clips, and/or to extract single frames used offline/online by the media recipient/requestor. If a single frame is specified, the data delivered may simply comprise a time of the segment.

### Promotional Clip Creation

As described above, embodiments of the invention may be utilized to create a promotional clip. In this regard, a module may allow the user to define several short segments of a full length episode or VAM (Value Added Materials) (e.g. trailers, interviews, B-Roll, etc.) elements in order to generate a broadcast quality file download that contains only the selected clips. The delivered promotional clip file may be compatible (or may be required to be compatible) with commonly used editing applications (e.g., Avid™ or Final Cut Pro™).

After a user 214 has defined the segments to be included in a promotional clip, the request for the clip is submitted for production. At this point, a request is sent from the Edit Bay™ website application 212 to an automated clip generation system (e.g., via an XML file drop into a “hot” folder). A “hot” folder as used herein is defined as a folder that is monitored or for which an event is triggered when a file is placed therein. The request from the application into the folder may include:
The Asset ID of the BQ (broadcast quality) file in the repository 208 (e.g., Esprit™) from which the clip file will be assembled from;
A list of segments to include in the clip file—defined by In/Out time pairs;
Technical fields detailing the file encoding and file wrapping specs of the clip file desired by the requestor;
An Edit Bay™ Request ID—to be included with the returned clip file; and
A System ID so the generation system knows which system to notify upon the completion of the task.

Once the request is received, the clip generation system (e.g., the web server application 112) collects the segments from the broadcast quality video, assemble them into a new clip file video, and transmits the “pickup location” and name of the newly created file (or a repository 208 asset ID) as well as the Request ID. The method by which the response is communicated back to the application (e.g., application 108) may be agreed upon by development teams of both a client editing application 108 and the clip generation software application. Additionally, the quality of the clip file may be required to match the quality of the source BQ file from which it is derived (i.e. there should be no transcoding or recompressing of the BQ source).

The editing application user/customer 214 will be notified via email when the new clip file has been created and will be able to click a link in an “Edit Queue” defined for that user in order to download the custom promo clip file.

To launch the Promo Clips module (e.g., within the website), the user will add a video to the Edit Bay Queue (e.g., step 306 from FIG. 3), then select “Promo Clip” from an “Actions” dropdown in the queue. Such a selection will launch the module with the selected video ready to edit.

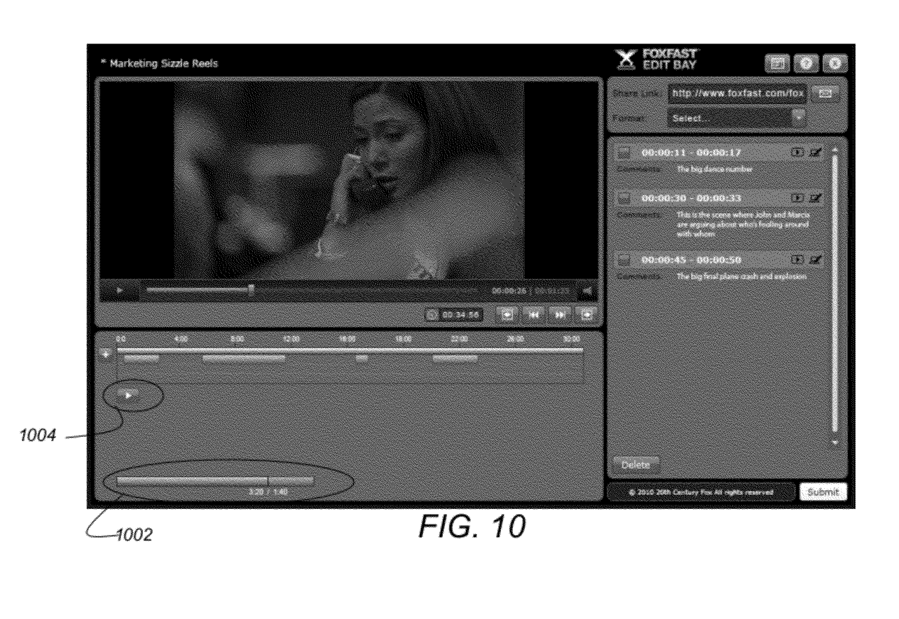

FIG. 10 illustrates a promo clips module with a selected video loaded in accordance with one or more embodiments of the invention. A status bar 1002 indicates the total amount of time used by the added segments and the amount of time remaining until the maximum length of time is reached. A play button 1004 plays only the defined segments. The play acts as a preview of the finished promotional clip. When the button 1004 is clicked, the preview will start playing from the current video time, if the current video time is within a defined segment. If the video is not currently within a defined segment then playback will start from the beginning of the next defined segment on the timeline. If there is no segment defined after the current video time then playback will start from the beginning of the first defined segment (i.e., the beginning of the preview).

To add a segment, the user can click an add icon (not shown) that will place the application in “add” mode. The “In” time will be prepopulated with the current time of the video. To create the edit, the user will define the “In” and “Out” times and enter the comments.

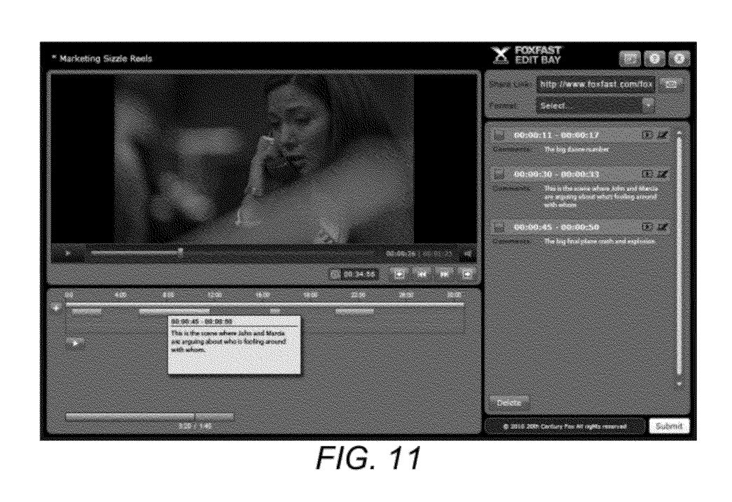

The promo clip module track display may differ from a multi-track module because all segments may appear on one track instead of each occupying a separate track. The segments appear on the track sequentially in chronological order and cannot overlap each other. When the user “hovers” the cursor above a track, the segment's appearance will change to a highlighted state and “tooltip” style popup will appear that displays the details of the edit. Such details may include “In” and “Out” times and comments. FIG. 11 illustrates edit details of a promotional clip in accordance with one or more embodiments of the invention.

To change/modify an edit, the user can double click on a track to place the application in “edit” mode with all the parameters of the edit pre-populated (e.g., the “In” and “Out” times as well as the comments). The user can proceed as described above with respect to the normal editing of a clip.

As described above, certain restrictions may be in place such as the inability for segment to overlap each other along a timeline. For example, if a segment exists between 14:22 and 14:37, no other segment can begin or end within this time span. The following are some examples of how this restriction affects the editing process:
A segment exists from 3:03 to 3:45. During playback, the “Add” button is disabled while the video is in this time period. This means the user cannot create a new segment during this time period and cannot modify a segment to begin or end during this time period.
A segment exists from 3:03 to 3:45. During playback, the “Add” button is disabled while the video is in this time period. Once the video has reached 3:46 (one second past the end of the existing segment) the “Add” button will be enabled. This means the user can create a new segment. Once the user clicks the “Add” button to mark the start of the segment, the user is placed in “Add” mode and is now restricted to a reduced timeline that starts at 3:46 and ends at the end of the video. The user cannot move backwards in the timeline beyond 3:46.
A segment exists from 3:03 to 3:45 and another from 4:30 to 5:00. During playback, the “Add” button is disabled while the video is between 3:03 and 3:45. Once the video has reached 3:46 (one second past the end of the existing segment) the “Add” buttons will be enabled. Now the user can create a new segment. Once the user clicks the “Add” button he is placed in edit mode and is now restricted to a reduced timeline that starts at 3:46 (one second after the end of the previous segment) and ends at 4:29 (one second before the beginning of the next segment). The user cannot move backwards in the timeline beyond 3:46 and cannot move forward beyond 4:29.

An additional restriction may exist with respect to the segment and total clip lengths. When creating a promo clip from an unaired episode, the length of the clip cannot exceed 5 minutes of promo video for each 30 minutes of video in the episode. For example, the user can create up to a 5 minute promo clip from a 30 minute episode, or a 10 minute promo video from a 60 minute episode. There may be no limit to the number of segments that comprise the overall promo clip. Further, there may be no length restrictions on promo clips created from all aired episodes or VAM videos.

The time limit can be enforced on a CLIENT basis (e.g., and NOT on a user basis). All the promo clips created by all the users within a given client cannot exceed the 5 minutes per 30 minutes limit for a given unaired episode. However, on a per client/customer basis, certain authorized personnel or services/maintenance may override and extend this limitation.

In addition to the above, the user can elect to include bars and tones and/or textless elements in their clip file request.

In addition, various workflow and permissions requirements may be enforced with respect to promotional clips (e.g., screener assets and/or broadcast quality assets). For example, a user may be required to be an approved broadcast VAM or approved broadcast full length user to submit a promotional clip request (for assets the user has rights to). Other users may have the ability to review and edit/create promotional clip records but not to submit a request for a promotional clip. In other words, within a content management/security system, users may have limited use authorization. Such limited use may prevent more than five (5) or ten (10) minutes of video segment time to be used and/or may prevent all licensed clients from viewing a screener. Thus, embodiments of the invention enable certain users to automatically request up to five (5)/ten (10) minutes of broadcast quality video, of particular broadcast specifications, determined from broadcast specification rights, of each episode a user is licensed to, but not permit the full download of the broadcast quality episode (e.g., by default).

### Promotional Clip Workflow

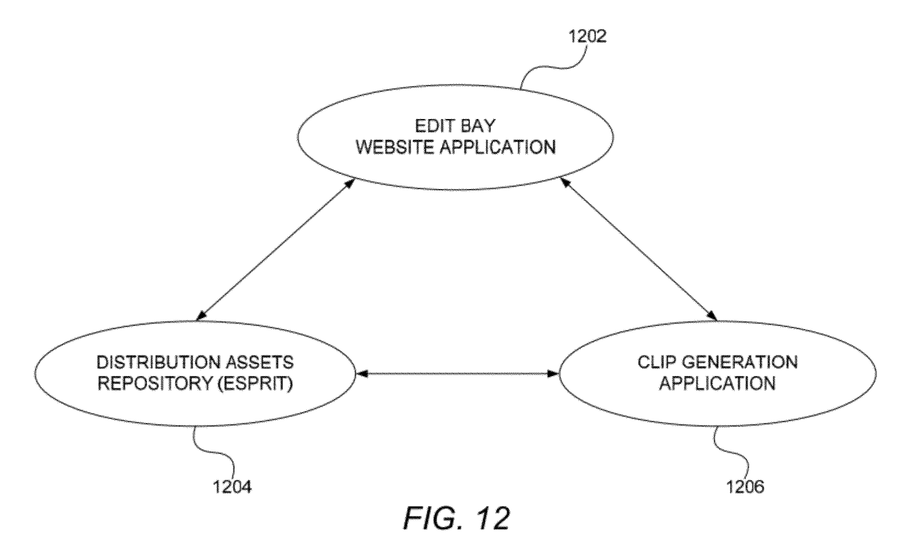

FIG. 12 illustrates the interaction between the different modules that may be used to create a promotional clip in accordance with one or more embodiments of the invention. As described above, the user (having appropriate authorization) using an edit bay website application 1202 submits a promotional clip request to a media content/distribution asset repository 1204. The clip request may contain a request identification as well as an identifier for the media content stored in the repository 1204. In addition, the request may be issued using a web service using BPEL. Thus, in one embodiment, the BPEL request from the edit bay application 1202 may request a path to the broadcast quality source file. In response, the repository 1204 may respond with the path. The web service may then render the request for processing by a clip generation application 1206 (e.g., Medway™). Such a render request may simply store the clip request ID and provide XML to the clip generation application 1206 that includes the source path/file and a BPEL job identification. The XML may be stored in a “hot folder” that is monitored by the clip generation application 1206.

The clip generation application 1206 monitors/watches the “hot folder” for the XML and then attempts to generate the promotional clip based on the information stored therein. If the application 1206 is unable to successfully render the request, fail information is generated, transmitted to the edit bay application 1202 (e.g., by placing in a fail “hot folder” that is monitored) and any created temporary files may be cleaned up. If successful, the output file(s) are stored in the repository 1204 (e.g., an output “hot folder”) and source XML may be copied to a different “success hot folder” in the repository 1204. Once a web service finds an entry in the success hot folder, the repository 1204 is used to serialize job IDs with filepaths to the new output file(s) and the web service notifies the edit pay application 1202 of the successful rendering (along with the request ID, the filepaths, and the status information).

After the above process has completed, the promotional clip is stored in the repository 1204 and must be downloaded by the user for use. The user in the edit bay application 1202 requests the download and an applet executing on the repository 1204 may be populated with all the files associated with the desired information. The applet may allow the user to select the local file path and download the appropriate files. In addition, the repository may clean-up and purge the output files after a predetermined amount of time (e.g., thirty [30] days).

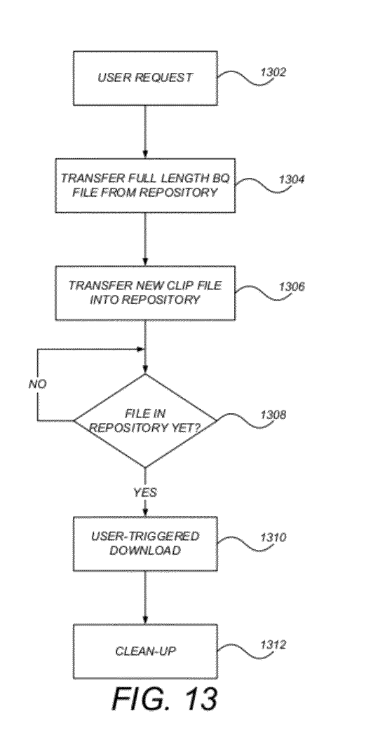

In view of the above, FIG. 13 illustrates a summary of the promotional clip workflow in accordance with one or more embodiments of the invention. At step 1302, the user requests the promotional clip (e.g., in edit bay application 1202). Such a request is performed after the user has performed the editing on the preview screening copy of the media content (e.g., specifying the media content to use, the in/out time identifiers, etc.). As described above, the editing may be performed using a single timeline track where segments appear sequentially in chronological order and cannot overlap each other.

At step 1304, the full length broadcast quality file is transferred from the repository 1204 (e.g., to the clip generation application 1206).

At step 1306, the new promotional clip file (created by the clip generation application 1206) is created and transferred into the repository 1204. To create/generate the clip, a clip generation process may monitor a “hot folder” for the promotional clip request. Such a monitoring may check with a frequency of every “xx” minutes. Once a request is stored in the hot folder, the clip generation application 1026 creates the clip. As described above, certain restrictions relating to the clip may be in place. For example, a length of the promotional clip may not be able to exceed a predetermined ratio of a segment length to a total clip length. Once the new broadcast quality promotional clip file is complete, a service may be deployed on the clip generation application 1206 server to push the file to the repository 1204.

At step 1308, the system waits until the new promotional clip file is in the repository 1204 (e.g., a “hot folder” is monitored).

At step 1310, once in the repository 1204, the user triggers a download of the new promotional clip.

At step 1312, the files in the repository are cleaned up (e.g., deleted from the repository 1204 after being downloaded by the user).

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

In summary, embodiments of the invention and the use of digital and file-based content delivery systems may provide a single web portal/system that enables the text based localization of content as part of a secure media content delivery system. More particularly, an editing application/area of the website is activated that provides the ability for a dubber to mark the relevant portion of a screener (i.e., media content available via a media content delivery system) and specify text that should be used within the marked content. The mark-up information may specify a time (i.e., down to a second) rather than a particular frame. In this regard, if a user identifies particular mark in/out information, the end system may select an appropriate frame to deliver or to use. Such a selection may be a random frame proximate to the time specified, may select the nearest I-frame, or may utilize any other technique to select a particular corresponding frame.

Once the dubber's process is complete, the mark in/out data and text information may be stored in a database and a notification may be presented to the media content owner (or editor) indicating the availability of such information for further processing. The recipient of the information may then elect to download the data which may be transmitted in XML that contains information similar to an EDL. In this regard, such information available to the recipient may be viewed as an XML-based EDL. Alternatively, an actual EDL may be provided that can be directly used by editing applications to perform the edits specified by the dubber.

In addition to the above, embodiments of the invention may allow the user to specify a clip, to create a promo clip, or to extract a single image. Embodiments of the invention may track/limit how many minutes of the media content the user is attempting to retrieve/utilize (thus providing a more secure environment for broadcast quality content). In addition, rather than delivering a large or entire video/media content (as required in the prior art where the localization is performed locally by end-users), only a small portion of the entire media content may be transmitted as the media content owner remains in control of the content. Further, the amount of time editors/dubbers take to perform the edits using the website/application may also be tracked to perform a cost analysis or to assess charges to/for the recipient of the edited media content.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system for editing media content in a computer system comprising:
(a) a server computer communicatively coupled to a repository of media content and enabled to provide access to the media content via a website accessible on the Internet worldwide to one or more client computers, wherein the website is configured to:
(i) provide preview screening access to licensed media content to one or more authorized client users, wherein the licensed media content is comprised of one or more titles of audio-visual media content; and
(ii) enable editing of the licensed media content using the preview screening.

2. The system of claim 1, wherein the editing comprises:
marking a clip of the licensed media content using in/out time identifiers; and
entering text for subtitling to be used in the clip.

3. The system of claim 1, wherein the editing comprises:
marking a clip of the licensed media content using in/out time identifiers; and
entering text for texted shots to be used in the clip.

4. The system of claim 1, wherein the editing comprises:
marking a clip of the licensed media content using in/out time identifiers; and
entering text for forced subtitles to be used in the clip.

5. The system of claim 1, wherein the editing comprises performing censorship edits.

6. The system of claim 1, wherein the editing comprises creating promotional materials.

7. The system of claim 6, wherein the creating promotional materials comprises:
the website receiving a request from a user to create a promotional clip;
transferring a full length broadcast quality file of the licensed media content to the repository, wherein the full length broadcast quality file can be downloaded by a clip generation application;
receiving, in the repository from the clip generation application, the promotional clip; and
the website enabling the one or more client computers to download the promotional clip from the repository.

8. The system of claim 6, wherein:
the promotional materials are edited using a single timeline track; and
one or more segments in the single timeline track appear sequentially in chronological order and cannot overlap each other.

9. The system of claim 6, wherein a length of the promotional clip cannot exceed a predetermined ratio of a segment length to a total clip length.

10. The system of claim 1, wherein the editing comprises identifying an image to capture as a high resolution still from a broadcast quality version of the licensed media content.

11. The system of claim 1, wherein the website is further configured to enable a user to:
log into the website to provide limited access to the media content stored in the repository;
search the media content for specific media content;
add the specific media content to an editing queue;
load an editing application configured to display the editing queue;
select the specific media content from the editing queue using the editing application;
edit the specific media content using the editing application;
save the edits to the specific media content; and
submit the saved edits.

12. The system of claim 11, wherein once the saved edits are submitted, the server is further configured to:
record a submission record based on the saved edits;
transmit an email notification indicating availability of the submission record; and
provide access to the submission record to authorized users.

13. A computer implemented method for editing media content, comprising:
(a) storing media content in a repository; and
(b) providing access to the media content via a website accessible on the Internet worldwide to one or more client computers, wherein the website is configured to:
(i) provide preview screening access to licensed media content to one or more authorized client users, wherein the licensed media content is comprised of one or more titles of audio-visual media content; and
(ii) enable editing of the licensed media content using the preview screening.

14. The method of claim 13, wherein the editing comprises:
marking a clip of the licensed media content using in/out time identifiers; and
entering text for subtitling to be used in the clip.

15. The method of claim 13, wherein the editing comprises:
marking a clip of the licensed media content using in/out time identifiers; and
entering text for texted shots to be used in the clip.

16. The method of claim 13, wherein the editing comprises:
marking a clip of the licensed media content using in/out time identifiers; and
entering text for forced subtitles to be used in the clip.

17. The method of claim 13, wherein the editing comprises performing censorship edits.

18. The method of claim 13, wherein the editing comprises creating promotional materials.

19. The method of claim 18, wherein the creating promotional materials comprises:
receiving, via the website, a request from a user to create a promotional clip;
transferring a full length broadcast quality file of the licensed media content to the repository, wherein the full length broadcast quality file can be downloaded by a clip generation application;
receiving, in the repository from the clip generation application, the promotional clip; and
enabling, via the website, the one or more client computers to download the promotional clip from the repository.

20. The method of claim 18, wherein:
the promotional materials are edited using a single timeline track; and
one or more segments in the single timeline track appear sequentially in chronological order and cannot overlap each other.

21. The method of claim 18, wherein a length of the promotional clip cannot exceed a predetermined ratio of a segment length to a total clip length.

22. The method of claim 13, wherein the editing comprises identifying an image to capture as a high resolution still from a broadcast quality version of the licensed media content.

23. The method of claim 13, wherein the website is further configured to enable a user to:
log into the website to provide limited access to the media content stored in the repository;
search the media content for specific media content;
add the specific media content to an editing queue;
load an editing application configured to display the editing queue;
select the specific media content from the editing queue using the editing application;
edit the specific media content using the editing application;
save the edits to the specific media content; and
submit the saved edits.

24. The method of claim 23, wherein once the saved edits are submitted, the server is further configured to:
record a submission record based on the saved edits;
transmit an email notification indicating availability of the submission record; and
provide access to the submission record to authorized users.

25. A computer readable storage medium encoded with computer program instructions which when accessed by a computer causes the computer to load the program instructions to a memory therein creating a special purpose data structure causing the computer to operate as a specially programmed computer, executing a method of editing media content, comprising:
(a) storing, in a repository, media content and marketing assets for the media content; and
(b) providing, in the specially programmed computer, access to the media content and marketing assets via a website accessible on the Internet worldwide to one or more client computers, wherein the website is configured to:
(i) provide preview screening access to licensed media content to one or more authorized client users, wherein the licensed media content is comprised of one or more titles of audio-visual media content; and
(ii) enable editing of the licensed media content using the preview screening.

26. The computer readable storage medium of claim 25, wherein the editing comprises:
marking a clip of the licensed media content using in/out time identifiers; and
entering text for subtitling to be used in the clip.

27. The computer readable storage medium of claim 25, wherein the editing comprises:
marking a clip of the licensed media content using in/out time identifiers; and
entering text for texted shots to be used in the clip.

28. The computer readable storage medium of claim 25, wherein the editing comprises:
marking a clip of the licensed media content using in/out time identifiers; and
entering text for forced subtitles to be used in the clip.

29. The computer readable storage medium of claim 25, wherein the editing comprises performing censorship edits.

30. The computer readable storage medium of claim 25, wherein the editing comprises creating promotional materials.

31. The computer readable storage medium of claim 30, wherein the creating promotional materials comprises:
the website receiving a request from a user to create a promotional clip;
transferring a full length broadcast quality file of the licensed media content to the repository, wherein the full length broadcast quality file can be downloaded by a clip generation application;
receiving, in the repository from the clip generation application, the promotional clip; and
the website enabling the one or more client computers to download the promotional clip from the repository.

32. The computer readable storage medium of claim 30, wherein:
the promotional materials are edited using a single timeline track; and
one or more segments in the single timeline track appear sequentially in chronological order and cannot overlap each other.

33. The computer readable storage medium of claim 30, wherein a length of the promotional clip cannot exceed a predetermined ratio of a segment length to a total clip length.

34. The computer readable storage medium of claim 25, wherein the editing comprises identifying a image to capture as a high resolution still from a broadcast quality version of the licensed media content.

35. The computer readable storage medium of claim 25, wherein the website is further configured to enable a user to:
log into the website to provide limited access to the media content stored in the repository;
search the media content for specific media content;
add the specific media content to an editing queue;
load an editing application configured to display the editing queue;
select the specific media content from the editing queue using the editing application;
edit the specific media content using the editing application;
save the edits to the specific media content; and
submit the saved edits.

36. The computer readable storage medium of claim 35, wherein once the saved edits are submitted, the server is further configured to:
record a submission record based on the saved edits;
transmit an email notification indicating availability of the submission record; and
providing access to the submission record to authorized users.
